(19) United States
(12) Patent Application Publication
(10) Pub. No.: US 2010/0063978 A1
(43) Pub. Date: Mar. 11, 2010

(54) APPARATUS AND METHOD FOR INSERTING/EXTRACTING NONBLIND WATERMARK USING FEATURES OF DIGITAL MEDIA DATA

(76) Inventors: Sang Kwang Lee, Daejeon (KR); Young Ho Suh, Daejeon (KR); Weon Geun Oh, Daejeon (KR); Won Gyum Kim, Daejeon (KR); Wonyoung Yoo, Daejeon (KR); Sung Hwan Lee, Daejeon (KR); Yong Seok Seo, Daejeon (KR); Hye Won Jung, Daejeon (KR); Seon Hwa Lee, Daejeon (KR); Young Suk Yoon, Seoul (KR); Seungjae Lee, Chungcheongnam-do (KR); Jin Soo Seo, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/516,614

(22) PCT Filed: Jul. 23, 2007
(86) PCT No.: PCT/KR2007/003537

§ 371 Date: May 28, 2009

(30) Foreign Application Priority Data
Dec. 2, 2006 (KR) 10-2006-0121083
Mar. 12, 2007 (KR) 10-2007-0024095

(51) Int. Cl. G06F 17/30; H04L 9/32

(52) U.S. Cl. 707/769; 713/176; 707/803; 707/E17.014

(57) ABSTRACT

An apparatus and method for inserting/extracting a nonblind watermark using features of digital media data are provided. The apparatus and method inserts a watermark adaptively using watermark-related information determined by analyzing the characteristics of digital media data, also extracts features of the digital media data, automatically searches original media data corresponding to the features, and simultaneously and efficiently extracts a watermark using watermark-related information. Therefore, When the watermark is extracted, the original media data can be searched automatically.

### TECHNICAL FIELD

The present invention relates to an apparatus and method for inserting/extracting a watermark into/from digital media data, and more particularly, to an apparatus and method for inserting/extracting a nonblind watermark using the features (i.e., unique characteristics) of digital media data, which can automatically search original media data using information about the features of digital media data robust against modification due to watermarking and can conveniently retrieve a water using watermark-related information.

### BACKGROUND ART

The digitalization of multimedia contents offers the advantage of easily copying and distributing original contents. However, illegal copies of the original contents can be infinitely generated, which seriously threatens music, film, book, publishing, and software industries.

Therefore, for the purpose of copyright protection, a study on digital watermarking that embeds hidden copyright information, serial number, etc. into digital contents is initiated. Watermarking methods are classified into a nonblind watermarking method and a blind watermarking method according to whether original media data can be used when a watermark is extracted.

In the nonblind watermarking method, original media data can be used when a watermark is extracted. In the blind watermarking method, original media data cannot be used when a watermark is extracted. Unlike the blind watermarking method, the nonblind watermarking method can insert a watermark strongly and unrecognizably. However, security preservation must be always secured to prevent the original media data from being disclosed, and the search of the original media data takes a lot of time when a huge media database is used for watermark extraction. Accordingly, the efficiency of the watermark extraction degrades greatly.

Atypical example of the nonblind watermarking method is disclosed in the paper of “Ingemar J. Cox, Joe Kilian, F. Thomson Leighton And Talal Shamoon, Secure Spread Spectrum Watermarking for Multimedia, IEEE Transaction on Image Processing, Vol. 6, No. 12, December 1997”.

In the nonblind watermarking method disclosed the paper, a watermark is retrieved using the difference between original media data and watermarked media data at a watermark insertion position. The presence of the watermark is determined using the correlation between an original watermark and the retrieved watermark.

In this nonblind watermarking method, the retrieval of a watermark is robust because original media data and an original watermark can be used. However, the original media data must be manually searched for the watermark retrieval. Moreover, a watermark cannot be adaptively inserted into host media data because a watermarking method, watermark data, a watermark insertion position, watermark intensity, etc. are fixed regardless of the host media data.

### DISCLOSURE OF INVENTION

### Technical Problem

It is an object of the present invention to provide an apparatus and method for inserting/extracting a nonblind watermark using the features (i.e., unique characteristics) of digital media data, which can retrieve a watermark efficiently by automatically searching original media data using the features of the digital media data robust against modification due to watermarking when the watermark is extracted.

It is another object of the present invention to provide an apparatus and method for inserting/extracting a nonblind watermark using the features of digital media data, which can adaptively insert/extract a watermark into/from host media data using watermark-related information such as a watermarking method, watermark data, a watermark insertion position, and watermark intensity that is determined according to the characteristics of media data.

### Technical Solution

To achieve these objects and other advantages and in accordance with the purpose of the invention, as embodied and broadly described herein, there is provided an apparatus for inserting a nonblind watermark using features of digital media data, including: a media database for storing one or more media data; an additional information database for storing watermark-related information corresponding to each of the media data stored in the media database; a watermark insertion module for, after host media data is determined from among the media data stored in the media database, searching the watermark-related information corresponding to the host media data from the additional information database, and inserting a watermark into the host media data according to the searched watermark-related information.

The watermark-related information includes a watermarking method, watermark data, a watermark insertion position, and watermark intensity. The media data stored in the media database and the watermark-related information stored in the additional information database are linked to each other through index values.

In another aspect of the present invention, there is provided an apparatus for extracting a nonblind watermark, including: a feature extraction module for extracting features from watermarked media data; a feature search module for searching corresponding original media data and watermark-related information using the extracted features; a watermark extraction module for extracting a watermark from the watermarked media data using the original media data and the watermark-related informat ion searched for by the feature search module.

The features are the unique characteristics of media data robust against modification due to watermarking. The feature search module searches features very similar to the extracted features from a feature database, and searches original media data and watermark-related information corresponding to the searched features.

In still another aspect of the present invention, there is provided a method for inserting a nonblind watermark, including the steps of: determining host media data from among media data; searching watermark-related information corresponding to the determined host media data from an additional information database,; inserting a watermark into the determined host media data using a watermark insertion module according to the searched watermark-related information.

In further still another aspect of the present invention, there is provided a method for extracting a nonblind watermark, including the steps of: extracting, at a feature extraction module, features from watermarked media data; searching, at a feature search module, original media data and watermark-related information corresponding to the extracted features using the extracted features; extracting, at a watermark extraction module, a watermark from the watermarked media data using the original media data and watermark-related information searched by the feature search module.

In even still further another aspect of the present invention, there is provided a method for constructing a watermark system, including the steps of: constructing a media database by storing one or more media data; constructing a feature database by extracting the features of each of the media data stored in the media database; storing, in an additional information database, watermark-related information including a watermarking method, watermark data, a watermark insertion position, and watermark intensity determined by analyzing each of the media data stored in the media database; linking the extracted features of the feature database corresponding to each of the media data of the media database, and the watermark-related information of the additional information database through index values.

### Advantageous Effects

The apparatus and method for inserting/extracting a nonblind watermark using the features (i.e., unique characteristics) of digital media data according to the present invention can efficiently extract a watermark by automatically searching, when the watermark is extracted, original media data using the features of media data and watermark-related information determined by the features of the media data.

Also, the apparatus and method can adaptively insert a watermark into host media data using the watermark-related information.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating the structure of a database of a watermark system according to the present invention;

FIG. 2 is a block diagram of an apparatus for inserting a nonblind watermark according to the present invention;

FIG. 3 is a block diagram of an apparatus for extracting a nonblind watermark according to the present invention;

FIG. 4 is a flowchart illustrating a method for inserting a nonblind watermark according to the present invention; and

FIG. 5 is a flowchart illustrating a method for extracting a nonblind watermark according to the present invention.

### BEST MODE FOR CARRYING OUT THE INVENTION

Reference will now be made in detail to the preferred embodiments of the present invention, examples of which are illustrated in the accompanying drawings.

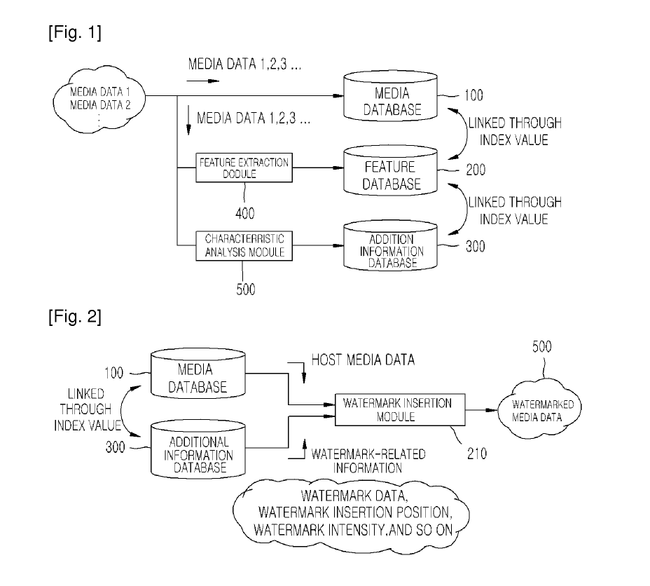

FIG. 1 is a diagram illustrating the structure of a database of a watermark system according to the present invention.

Referring to FIG. 1, the database of the watermark system includes a media database 100, a feature database 200, and an additional information database 300.

The media database 100 stores one or more media data that will be protected by copyright. The media data may include one or more of image data, audio data, and video data.

The feature database 200 stores the features of each of the media data stored in the media database 100. The features of the media data represent the unique characteristics of the media data that are used for media data identification.

For example, image data or video data include visual characteristics such as color, texture, and motion. Features such as dominant color, edge histogram, and motion trajectory may be used for the media data identification in the image data or video data.

Such features of the media data need to be robust against a certain level of intentional or unintentional attack as well as modification due to watermarking. The features of the media data are extracted by a feature extraction module 400 from the media data and are stored in the feature database 200.

The additional information database 300 stores watermark-related information such as a watermarking method, watermark data, a watermark insertion position, and watermark intensity determined through characteristic analysis of each of the media data stored in the media database 100.

A characteristic analysis module 500 analyzes the characteristics of each of the media data, determines the watermark-related information for each of the media data, and stores the determined watermark-related information in the additional information database 300.

Each of the media data, the features, and the watermark-related information stored in the media database 100, the feature database 200, and the additional information database 300 respectively are linked to each other through index values.

Therefore, when only one of the media data, the features, and the watermark-related information is known, the others become known. For example, when the features are known, the media data having the features, and the watermark-related information become known.

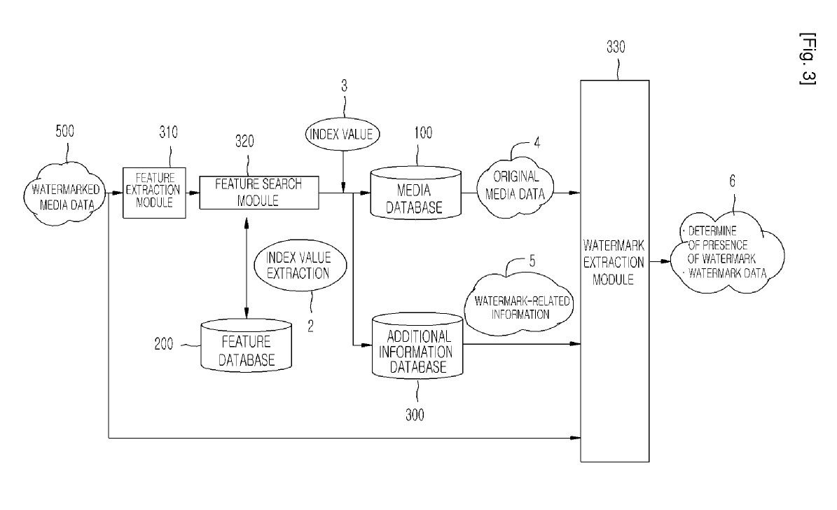

FIG. 2 is a block diagram of an apparatus for inserting a nonblind watermark according to the present invention.

Referring to FIG. 2, the apparatus includes a media database 100, an additional information database 300, and a watermark insertion module 210.

The media database 100 stores one or more media data.

The additional information database 300 stores watermark-related information according to the characteristics of each of the media data stored in the media database 100. The watermark-related information includes a watermarking method, watermark data, a watermark insertion position, and watermark intensity.

The media data of the media database 100 and the watermark-related information of the additional information database 300 are linked to each other through index values. Each of the media data corresponds to different watermark-related information.

After host media data for watermarking is selected by user, the watermark insertion module 210, searches watermark-related information linked to the host media data through an index value. After the watermark-related information are searched, the watermark insertion module 210 watermarks the host media data using a watermarking method, watermark data, a watermark insertion position, and watermark intensity included in the watermark-related information, and outputs the watermarked media data 500.

FIG. 3 is a block diagram of an apparatus for extracting a nonblind watermark according to the present invention.

Referring to FIG. 3, the apparatus includes a feature extraction module 310, a feature search module 320, and a watermark extraction module 330.

The feature extraction module 310 extracts features from watermarked media data 500 in order to extract a watermark from the watermarked media data 500.

The feature search module 320 searches original media data using the features extracted by the feature extraction module 310. Information stored in a feature database 200 and media database 100 is used to search the original media data.

The feature search module 320 searches features equal to or very similar to the extracted features from the feature database 200. The original media data corresponding to the watermarked media data 500 are searched from the media database 100.

Each of the features searched from the feature database 200 has a different index value. Accordingly, the original media data having the same or corresponding index value are searched from the media database 100.

Also, the feature search module 320 searches, from the additional information database 300, watermark-related information 5 corresponding to an index value 3 of the searched features.

After the original media data 4 and watermark-related information 5 corresponding to the watermarked media data 500 are searched, the watermark extraction module 330 compares the watermarked media data 500 with the original media data 4. Also, the watermark extraction module 330 determines whether the watermark is inserted using the watermark-related information 5, and extracts the watermark simultaneously.

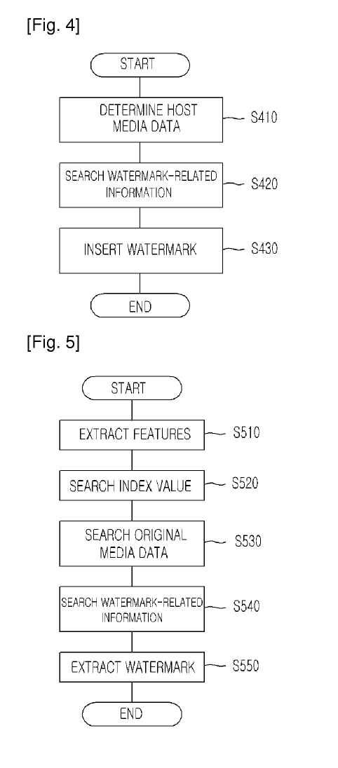

FIG. 4 is a flowchart illustrating a method for inserting a nonblind watermark according to the present invention.

Referring to FIG. 4, the method includes the step 5410 of determining host media data, the step 5420 of searching watermark-related information, and the step 5430 of inserting a watermark.

In the step 5410, the host media data is determined from among media data stored in a media database 100 in order that the watermark is inserted by user.

In the step 5420, the watermark-related information linked to the host media data through an index value is searched from the additional information database 300.

In the step 5430, the watermark insertion module 210 inserts the watermark into the host media data using the watermark-related information.

FIG. 5 is a flowchart illustrating a method for extracting a nonblind watermark according to the present invention.

Referring to FIG. 5, the method includes the step 5510 of extracting features, the step

S520 of searching an index value, the step 5530 of searching original media data, the step 5540 of searching watermark-related information, and the step 5550 of extracting a watermark.

In the step 5510, the feature extraction module 310 extracts the features from watermarked media data 500.

In the step 5520, a feature search module 320 searches the index value from a feature database 200 using the features extracted by the feature extraction module 310. Each of features stored in the feature database 200 has a different index value, and is linked to different original media data 4 of a media database 100 and watermark-related information 5 of an additional information 320 through different index values.

In the step 5530, original media data 4 linked to the extracted features through the searched index value is searched from the media database 100.

In the step 5540, the watermark-related information 5 linked to the extracted features through the searched index value is searched from an additional information database 300.

In the step 5550, it is determined if the watermark is inserted in the watermarked media data 500 using the searched original media data 4 and watermark-related information 5, and if so, the watermark is extracted.

It will be apparent to those skilled in the art that various modifications and variations can be made in the present invention. Thus, it is intended that the present invention covers the modifications and variations of this invention provided they come within the scope of the appended claims and their equivalents.

1. An apparatus for inserting a nonblind watermark, comprising:
a media database for storing one or more media data;
an additional information database for storing watermark-related information corresponding to each of the media data stored in the media database;
a watermark insertion module for, after host media data is determined from among the media data stored in the media database, searching the watermark-related information corresponding to the host media data from the additional information database, and inserting a watermark into the host media data according to the searched watermark-related information.

2. The apparatus of claim 1, wherein the media data comprises one or more of image data, audio data, and video data.

3. The apparatus of claim 1, wherein the watermark-related information comprises a watermarking method, watermark data, a watermark insertion position, and watermark intensity.

4. The apparatus of claim 1, wherein the media data stored in the media database and the watermark-related information stored in the additional information database are linked to each other through index values.

5. An apparatus for extracting a nonblind watermark, comprising:
a feature extraction module for extracting features from watermarked media data;
a feature search module for searching corresponding original media data and watermark-related information using the extracted features;
a watermark extraction module for extracting a watermark from the watermarked media data using the original media data and the watermark-related information searched by the feature search module.

6. The apparatus of claim 5, wherein the features are the unique characteristics of media data robust against modification due to watermarking.

7. The apparatus of claim 5, wherein the feature search module searches, from a feature database, features very similar to the extracted features, and searches original media data and watermark-related information corresponding to the searched features.

8. The apparatus of claim 7, wherein the original media data and the watermark-related information are stored in a media database and an additional information database respectively.

9. The apparatus of claim 8, wherein the original media data and the watermark-related information are searched using an index value of the extracted features.

10. The apparatus of claim 5, wherein the watermark-related information comprises a watermarking method, watermark data, a watermark insertion position, and watermark intensity.

11. A method for inserting a nonblind watermark, comprising the steps of:
determining host media data from among media data;
searching watermark-related information corresponding to the determined host media data from an additional information database;
inserting a watermark into the determined host media data at a watermark insertion module according to the searched watermark-related information.

12. The method of claim 11, wherein the media data comprises one or more of image data, audio data, and video data.

13. The method of claim 11, wherein the watermark-related information comprises a watermarking method, watermark data, a watermark insertion position, and watermark intensity.

14. The method of claim 11, wherein the step of searching the watermark-related information comprises the step of searching, from the additional database, the watermark-related information linked to an index value of the determined host media data.

15. A method for extracting a nonblind watermark, comprising the steps of:
extracting, at a feature extraction module, features from watermarked media data;
searching, at a feature search module, original media data and watermark-related information corresponding to the extracted features using the extracted features;
extracting, at a watermark extraction module, a watermark from the watermarked media data using the original media data and watermark-related information searched by the feature search module.

16. The method of claim 15, wherein the step of extracting the features comprises the step of extracting the unique characteristics of media data, which is robust against modification due to watermarking, as the features.

17. The method of claim 15, wherein the step of searching the original media data and watermark-related information comprises the step of searching the original media data linked to an index value of the extracted features from among the original media data stored in a media database.

18. The method of claim 15, wherein the step of searching the original media data and watermark-related information comprises the step of searching, from among the watermark-related information stored in an additional information database, the watermark-related information linked to an index value of the extracted features.

19. The method of claim 15, wherein the watermark-related information comprises a watermarking method, watermark data, a watermark insertion position, and watermark intensity.

20. A method for constructing a watermark system, comprising the steps of:
constructing a media database by storing one or more media data;
constructing a feature database by extracting the features of each of the media data stored in the media database;
storing, in an additional information database, watermark-related information including a watermarking method, watermark data, a watermark insertion position, and watermark intensity determined by analyzing each of the media data stored in the media database;
linking the extracted features of the feature database corresponding to each of the media data of the media database and the watermark-related information of the additional information database through index values.

21. The method of claim 20, wherein the extracted features are the unique characteristics of media data robust against modification due to watermarking.

22. The method of claim 20, further comprising, after host media data is determined from among the media data stored in the media database, the step of inserting a watermark into the determined host media data using the watermark-related information linked to an index value of the determined host media data.

23. The method of claim 20, the media data comprises one or more of image data, audio data, and video data.
